(19) United States
(12) Patent Application Publication
(10) Pub. No.: US 2016/0260374 A1
(43) Pub. Date: Sep. 8, 2016

(54) DISPLAY DEVICE

(71) Applicant: Sharp Kabushiki Kaisha, Osaka-shi, Osaka (JP)

(72) Inventors: Naoto INOUE, Osaka-shi (JP); Akira TOMIYOSHI, Osaka-shi (JP); Aya NAKATANI, Osaka-shi (JP)

(21) Appl. No.: 15/030,408

(22) PCT Filed: Oct. 16, 2014
(86) PCT No.: PCT/JP2014/077588

§ 371 Date: Apr. 19, 2016

(30) Foreign Application Priority Data
Nov. 5, 2013 (JP) 2013-229558

(51) Int. Cl. G09G 3/20

(52) U.S. Cl. CPC G09G 3/2096; G09G 2330/021

(57) ABSTRACT

A display device capable of accurately supplying a voltage used to generate a gate signal and a voltage used to drive a nonvolatile memory is provided using a simple configuration. A DC/DC converter 20 switches between a first state of converting an input voltage (Vin) into a voltage (Vs) used to drive a nonvolatile memory and a second state of converting the input voltage (Vin) into a voltage (Vg) used to generate a gate signal.

### TECHNICAL FIELD

The present invention relates to a display device.

### BACKGROUND ART

In an active matrix addressed liquid crystal display device, a binary gate voltage Vg with two values, a predetermined high voltage VGH and a predetermined low voltage VGL, is supplied to a gate terminal of a TFT provided at each pixel via a gate line to control turn-on and turn-off of the TFT. The high voltage VGH and the low voltage VGL are generated from an input voltage Vin (for example, 3.3 V) input from the outside by a DC/DC converter in a driving circuit of the liquid crystal display device.

A source driver generates a binary write voltage with two values, a high voltage and a low voltage, as a voltage for driving a nonvolatile memory of the source driver.

A voltage value (VGH/VGL) which the gate voltage Vg is required to have is defined by TFT characteristics and the electrical characteristics of a liquid crystal cell, and a voltage value which the write voltage is required to have is defined by charge retention characteristics of the nonvolatile memory.

For this reason, the voltage values required for the gate voltage Vg and the write voltage are different from each other. It is unpreferable to generate the gate voltage Vg and the write voltage from a high voltage and a low voltage which are generated using a single DC/DC converter.

One conceivable method for suppling two different types of voltages is to use a DC/DC converter which generates a high voltage and a low voltage for the gate voltage and a DC/DC converter which generates a high voltage and a low voltage for the write voltage, as shown in FIG. 12.

PTL 1 to PTL 3 each describe a driving circuit including an internal power source control circuit which generates a power source voltage at a predetermined level needed inside a circuit on the basis of two types of input power sources. A driving circuit for a display device in PTL 3 includes a level shifter circuit which is connected to a 12-V power source and a 40-V power source via switches, and the level shifter circuit is shared between a gate driver driving circuit and a nonvolatile memory driving circuit. This configuration allows a reduction in the number of level shifter circuits and a reduction in the area of driving circuits.

### CITATION LIST

### Patent Literature

PTL 1: Japanese Unexamined Patent Application Publication No. 2012-230398 (laid open on Nov. 22, 2012)

PTL 2: Japanese Patent No. 5057417 (registered on Aug. 10, 2012)

PTL 3: Japanese Patent No. 4907908 (registered on Jan. 20, 2012)

### SUMMARY OF INVENTION

### Technical Problem

However, the use of the two DC/DC converters for generating the gate voltage and the write voltage causes an increase in cost and an increase in power consumption and is thus unpreferable. Additionally, if the two DC/DC converters are simultaneously driven and controlled in parallel, different output voltages are applied onto a single piece of wiring. This may lead to the difficulty in controlling the DC/DC converters and may cause a malfunction or a breakage.

The display device in PTL 3 requires two input power sources. Since two types of power source voltages are input to one level shifter circuit, accurate output control is difficult in the level shifter circuit.

The present invention has been made in view of the above-described bibliographical notes, and has as its object to provide a display device capable of accurately supplying a voltage used to generate a gate signal and a voltage used to drive a nonvolatile memory, using a simple configuration.

### Solution to Problem

In order to solve the above-described problems, a display device according to one aspect of the present invention is a display device including a scanning line driving circuit which generates a gate signal for sequentially bringing pixels into a selected state and a signal line driving circuit which generates a data signal to be supplied to the pixel on the basis of a picture to be displayed, the signal line driving circuit including a nonvolatile memory, in which the display device includes a voltage conversion unit which converts an input voltage supplied from the outside into an output voltage with a different voltage value and outputs the output voltage, and the voltage conversion unit switches between a first state of converting the input voltage into a first output voltage used to drive the nonvolatile memory and a second state of converting the input voltage into a second output voltage used to generate the gate signal.

In order to solve the above-described problems, a display device according to one aspect of the present invention is a display device including a scanning line driving circuit which generates a gate signal for sequentially bringing pixels into a selected state and a signal line driving circuit which generates a data signal to be supplied to the pixel on the basis of a picture to be displayed, the signal line driving circuit including a nonvolatile memory, in which the display device includes a first voltage conversion unit which converts an input voltage supplied from the outside into a first output voltage used to drive the nonvolatile memory and outputs the first output voltage and a second voltage conversion unit which converts the input voltage into a second output voltage used to generate the gate signal and outputs the second output voltage, and the second voltage conversion unit stops operation during a period when the first voltage conversion unit outputs the first output voltage, and the first voltage conversion unit stops operation during a period when the second voltage conversion unit outputs the second output voltage.

In order to solve the above-described problems, a display device according to one aspect of the present invention is a display device including a scanning line driving circuit which generates a gate signal for sequentially bringing pixels into a selected state and a signal line driving circuit which generates a data signal to be supplied to the pixel on the basis of a picture to be displayed, the signal line driving circuit including a nonvolatile memory, in which the display device includes a voltage conversion unit which converts an input voltage supplied from the outside and outputs, as an output voltage, one of a first output voltage used to drive the nonvolatile memory and a second output voltage used to generate the gate signal, an input terminal which is supplied with a second input voltage equal to a voltage value of the other of the first output voltage and the second output voltage from the outside, and a switching element which controls a condition of connection between the input terminal and the scanning line driving circuit or the nonvolatile memory, and the switching element is in an unconnected state during a period when the voltage conversion unit outputs the output voltage and is in a connected state during a period when the voltage conversion unit does not output the output voltage.

### Advantageous Effects of Invention

According to one aspect of the present invention, it is possible to provide a display device capable of accurate display control, using a simple configuration.

### BRIEF DESCRIPTION OF DRAWINGS

FIG. 1 is a schematic view of a liquid crystal display device according to a first embodiment of the present invention.

FIG. 2 is a block diagram showing the configuration of the liquid crystal display device according to the first embodiment of the present invention.

FIG. 3 is a table showing the relationship between the on-off state of an FET and an output voltage from a DC/DC converter.

FIG. 4 is a block diagram for explaining switching of the output voltage from the DC/DC converter.

FIG. 5 is a circuit diagram showing the configuration of a voltage dividing circuit according to a modification of the first embodiment.

FIG. 6 is a block diagram showing the configuration of a liquid crystal display device according to a second embodiment of the present invention.

FIG. 7 is a table showing the relationship between the operation of two DC/DC converters and an output voltage from the DC/DC converters.

FIG. 8 is a schematic view of a liquid crystal display device according to a third embodiment of the present invention.

FIG. 9 is a block diagram showing the configuration of the liquid crystal display device according to the third embodiment of the present invention.

FIG. 10 is a circuit diagram showing a specific configuration of connectors.

FIG. 11 is a table showing the relationship between the operation of a DC/DC converter and an FET, and an output voltage from a circuit board.

FIG. 12 is a block diagram showing the configuration of a conventional liquid crystal display device.

### DESCRIPTION OF EMBODIMENTS

### First Embodiment

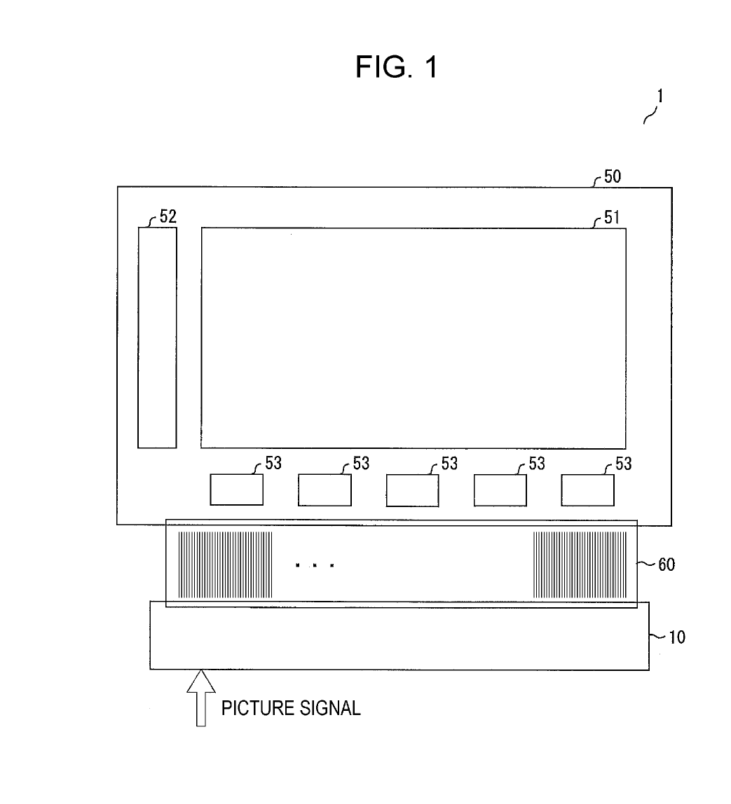

An embodiment of the present invention will be described in detail below with reference to FIGS. 1 to 5. A liquid crystal display device will be illustrated below as an example of a display device, to which the present invention is applied. The present invention can also be applied to another active matrix addressed display device, such as an organic EL display device.

FIG. 1 is a schematic view of a liquid crystal display device according to a first embodiment. A liquid crystal display device 1 includes a liquid crystal panel 50 and a circuit board 10. The circuit board 10 and the liquid crystal panel 50 are connected via a flexible printed circuit 60 for connection.

### <Liquid Crystal Panel>

The liquid crystal panel 50 includes a display unit 51, a gate driver 52 (a scanning line driving circuit), and a source driver 53 (a signal line driving circuit).

A plurality of scanning signal lines (not shown) extending in a horizontal direction in the drawing and a plurality of data signal lines (not shown) extending in a vertical direction in the drawing are arranged at the display unit 51. One end of each scanning signal line is connected to the gate driver 52 while one end of each data signal line is connected to the source driver 53.

A plurality of pixels, which are each a region surrounded by scanning signal lines and data signal lines, are also formed at the display unit 51. The display unit 51 has a TFT (switching element) and a pixel electrode provided so as to correspond to each pixel.

A gate terminal of each TFT is connected to a scanning signal line, a source terminal is connected to a data signal line, and a drain terminal is connected to a pixel electrode.

The gate driver 52 generates a gate signal on the basis of a signal supplied from the circuit board and supplies the gate signal to each scanning signal line, thereby sequentially bringing the pixels into a selected state. The source driver 53 generates a data signal on the basis of a signal supplied from the circuit board and writes the data signal to a pixel in a selected state via a data signal line and a TFT. In the above-described manner, a display is provided on the display unit 51.

Note that the source driver 53 is provided with a nonvolatile memory for storing various types of settings.

### <Circuit Board>

The circuit board 10 generates various types of signals for driving the gate driver 52 and the source driver 53 on the basis of picture signals supplied from the outside. The various types of signals are supplied to the gate driver 52 and the source driver 53 via the flexible printed circuit 60 for connection.

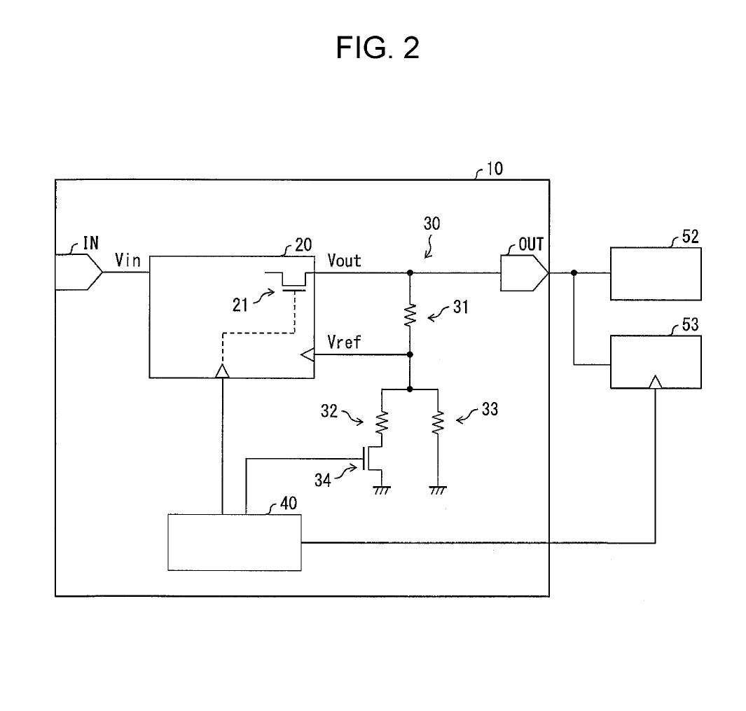

FIG. 2 is a block diagram showing the configuration of the liquid crystal display device according to the first embodiment.

As shown in FIG. 2, the circuit board 10 has an input terminal IN (a connector), a DC/DC converter 20 (a voltage conversion unit), a voltage dividing circuit 30 (a reference resistor), a timing controller 40, and an output terminal OUT.

A predetermined input voltage Vin is supplied from an external power source to the input terminal IN. The input voltage Vin is, for example, 3.3 V.

The timing controller 40 supplies a signal which serves as a reference signal for circuits to operate in synchronization to the circuits on the basis of a horizontal synchronizing signal and a vertical synchronizing signal input from a control unit (not shown). More specifically, the timing controller 40 supplies a gate start pulse signal and a gate clock signal to the gate driver 52 on the basis of the vertical synchronizing signal. The timing controller 40 supplies a source start pulse signal, a source latch strobe signal, a source clock signal, and a picture signal corresponding to an input image to the source driver 53 on the basis of the horizontal synchronizing signal.

Additionally, the timing controller 40 supplies an output control signal for controlling activation and deactivation of the DC/DC converter 20 to the DC/DC converter 20, supplies an operation control signal for controlling activation and deactivation of the source driver 53 to the source driver 53, and supplies a switch control signal for controlling turn-on and turn-off of an FET 34 to a gate terminal of the FET 34.

The DC/DC converter 20 converts the input voltage Vin supplied from the outside via the input terminal IN into an output voltage Vout with a different voltage value and outputs the output voltage Vout. The output voltage Vout from the DC/DC converter 20 is supplied to the gate driver 52 and the source driver 53 via the output terminal OUT. The DC/DC converter 20 includes an FET 21 for operation control and switches between producing and not producing an output in accordance with the on-off state of the FET 21 for operation control.

The voltage dividing circuit 30 includes a resistor 31 as an input-side resistor unit, and a resistor 32 (a first resistor) and a resistor 33 (a second resistor) as a ground-side resistor unit which are connected in parallel to each other.

The FET 34 is provided between the resistor 32 and the ground. The FET 34 has the gate terminal connected to the timing controller 40, a source terminal grounded, and a drain terminal connected to the resistor 32. The voltage dividing circuit 30 can change a resistance value of the ground-side resistor unit by controlling turn-on and turn-off of the FET 34, which results in a change in an output voltage (a midpoint potential) from the voltage dividing circuit 30.

The voltage dividing circuit 30 receives the output voltage Vout from the DC/DC converter 20 and outputs a voltage in accordance with a resistance value of the input-side resistor unit and the resistance value of the ground-side resistor unit. The output voltage from the voltage dividing circuit 30 is supplied to the DC/DC converter 20.

The DC/DC converter 20 refers to the output voltage from the voltage dividing circuit 30 as a reference voltage Vref and performs feedback control on the output voltage Vout such that the reference voltage Vref is a constant voltage.

Note that although a configuration in which the timing controller 40 supplies a switch control signal to the gate terminal of the FET 34 and supplies an output control signal to the DC/DC converter 20 has been described above, the present invention is not limited to this. Instead of the timing controller 40, the source driver 53 may supply a switch control signal and an output control signal.

### <Output Voltage Vout>

The DC/DC converter 20 according to the present embodiment can switch a voltage value of the output voltage Vout by switching between a first state of converting the input voltage Vin supplied from the outside into a voltage Vs (a first output voltage) used to drive the nonvolatile memory and a second state of converting the input voltage Vin into a voltage Vg (a second output voltage) used to generate a gate signal. The details will be described below.

In the first state, a signal at a low potential is supplied from the timing controller 40 to the gate terminal of the FET 34, and the FET 34 is turned off. As described above, the DC/DC converter 20 performs feedback control on the output voltage Vout such that the reference voltage Vref is a constant voltage. For this reason, letting R1 be a resistance value of the resistor 31; R2 be a resistance value of the resistor 32; and R3 be a resistance value of the resistor 33, the output voltage Vout in the first state is given by:

Vout=(1+R1/R3)×Vref

In contrast, in the second state, a signal at a high potential is supplied from the timing controller 40 to the gate terminal of the FET 34, and the FET 34 is turned on. For this reason, letting R23 be a combined resistance of R2 and R3 (R2//R3), the output voltage Vout in the first state is given by:

Vout=(1+R1/R23)×Vref

As described above, the DC/DC converter 20 can output the output voltage Vout in the first state and the output voltage Vout in the second state and can switch between outputting one of two types of different voltages and outputting the other.

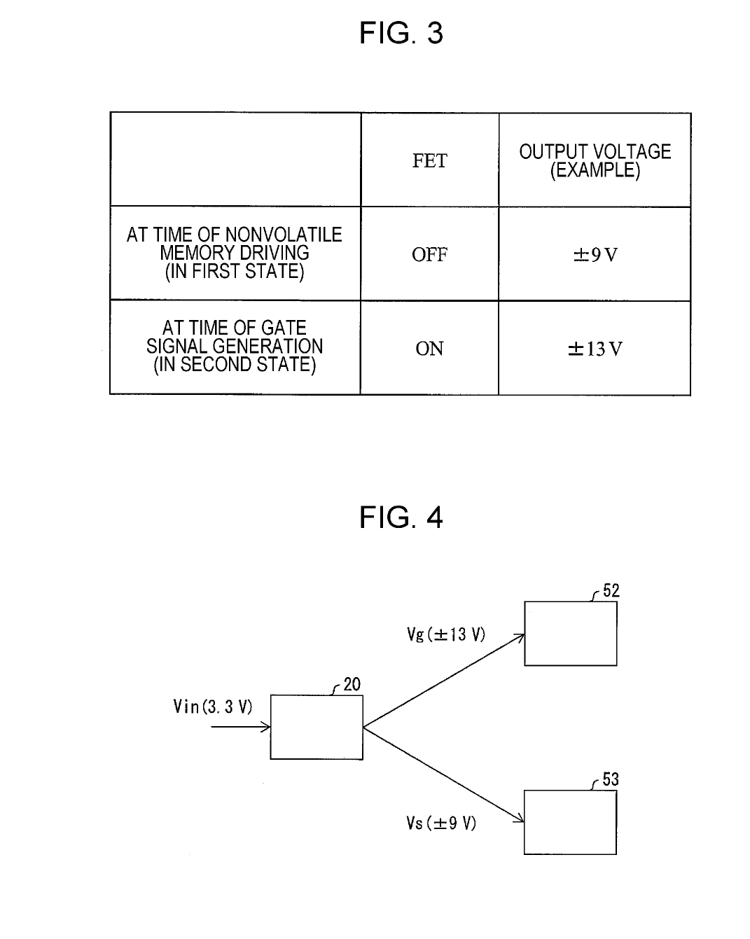

FIG. 3 is a table showing the relationship between the on-off state (the open-close state) of the FET 32 and the output voltage from the DC/DC converter 20.

As shown in FIG. 3, for example, the output voltage Vout in the first state is set at ±9 V and is supplied to the source driver 53. This allows driving of the nonvolatile memory inside the source driver 53 and data writing to and data erasure from the nonvolatile memory. The output voltage Vout in the second state is set at ±13 V and is supplied to the gate driver 52. This allows the gate driver 52 to generate a gate signal.

FIG. 4 is a block diagram for explaining switching of the output voltage from the DC/DC converter 20. As shown in FIG. 4, the liquid crystal display device 1 according to the present embodiment can generate two types of different output voltages Vout (Vg and Vs) from the single input voltage Vin using the single DC/DC converter 20 and supply the output voltages Vout to the gate driver 52 and the source driver 53.

The liquid crystal display device 1 can generate the two types of output voltages Vout without using a plurality of DC/DC converters and is thus capable of achieving a size reduction, a power consumption reduction, and a cost reduction of the circuit board 10 as compared to a conventional liquid crystal display device.

### <Modification>

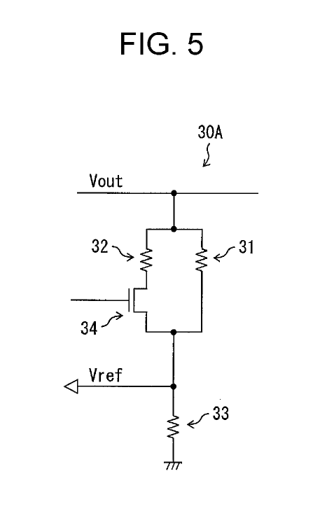

Note that the circuit configuration of the voltage dividing circuit 30 is not limited to the configuration shown in FIG. 2. FIG. 5 is a circuit diagram showing the configuration of a voltage dividing circuit according to a modification.

A voltage dividing circuit 30A according to the modification includes the resistors 31 and 32 as an input-side resistor unit that are connected in parallel to each other, and the resistor 33 as a ground-side resistor unit. As described above, a voltage dividing circuit may be configured to be capable of changing a resistance value of an input-side resistor unit.

### Second Embodiment

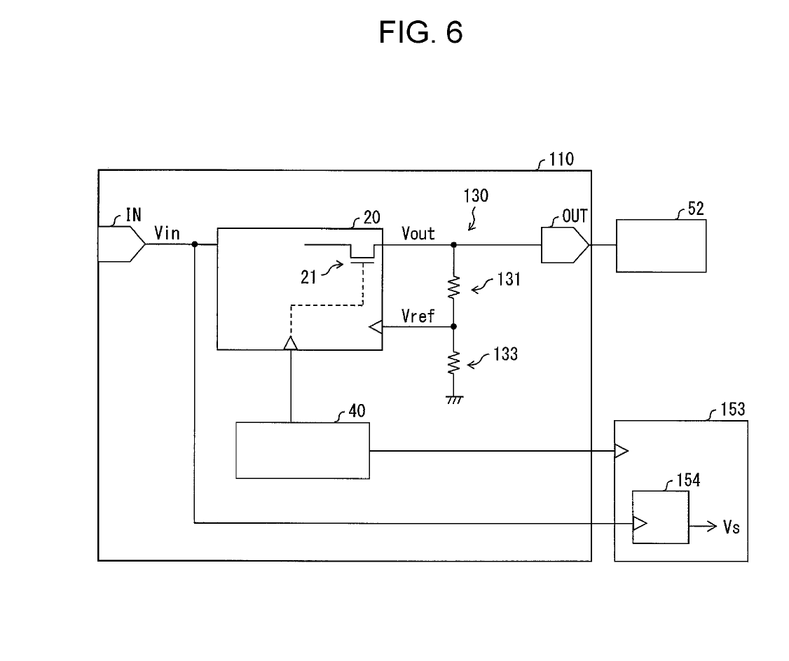

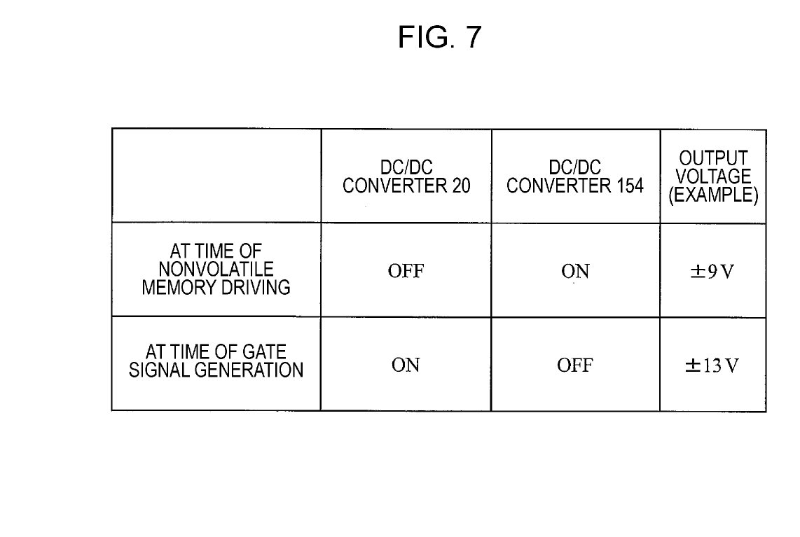

Another embodiment of the present invention will be described with reference to FIGS. 6 and 7 as follows. Note that, for convenience of illustration, members having the same functions as those of the members described in the above-described embodiment are denoted by the same reference characters, and a description thereof will be omitted.

FIG. 6 is a block diagram showing the configuration of a liquid crystal display device according to a second embodiment.

The liquid crystal display device according to the present embodiment includes a DC/DC converter 154 (a second voltage conversion unit) in a source driver 153 in addition to a DC/DC converter 20 (a first voltage conversion unit).

The DC/DC converter 20 converts an input voltage Vin into a voltage Vg (a second output voltage) used to generate a gate signal, and the DC/DC converter 154 converts the input voltage Vin into a voltage Vs (a first output voltage) used to drive a nonvolatile memory. For example, the voltage Vg is ±13 V, and the voltage Vs is ±9 V. Note that the DC/DC converter 154 need not be provided inside the source driver 153 and may be provided outside the source driver 153.

Activation and deactivation of the DC/DC converter 20 is controlled in accordance with an output control signal from a timing controller 40, and the DC/DC converter 20 can be in a high impedance state during shutdown. Activation and deactivation of each of the source driver 153 and the DC/DC converter 154 is controlled in accordance with an operation control signal from the timing controller 40.

An output from the DC/DC converter 20 is input to a voltage dividing circuit 130 which is composed of a resistor 131 and a resistor 132, and an output from the voltage dividing circuit is input as a reference voltage Vref to the DC/DC converter 20.

FIG. 7 is a table showing the relationship between the operation of the two DC/DC converters and an output voltage from the DC/DC converters.

The liquid crystal display device according to the present embodiment generates the voltage Vs by deactivating (turning off) the DC/DC converter 20 and activating (turning on) the DC/DC converter 154 and supplies the voltage Vs to the nonvolatile memory, at the time of driving the nonvolatile memory under control of the timing controller 40. In contrast, at the time of gate signal generation (at the time of liquid crystal panel gate driving), the liquid crystal display device generates the voltage Vg by deactivating (turning off) the DC/DC converter 154 and activating (turning on) the DC/DC converter 20 and supplies the voltage Vg to the gate driver 52, under control of the timing controller 40.

That is, the liquid crystal display device according to the present embodiment switches a DC/DC converter to operate between the two DC/DC converters under control of the timing controller 40.

For this reason, the DC/DC converter 20 stops operation during a period when the DC/DC converter 154 outputs the voltage Vs, and the DC/DC converter 154 stops operation during a period when the DC/DC converter 20 outputs the voltage Vg.

With the above-described configuration, the liquid crystal display device according to the present embodiment can output two types of voltages (Vg and Vs).

Note that since pieces of data can be written one by one to a nonvolatile memory built into each of a plurality of source drivers 153 in chronological order, the plurality of DC/DC converters need not be simultaneously driven. This facilitates DC/DC converter control and allows a reduction in the risk of causing a malfunction or a breakage.

### Third Embodiment

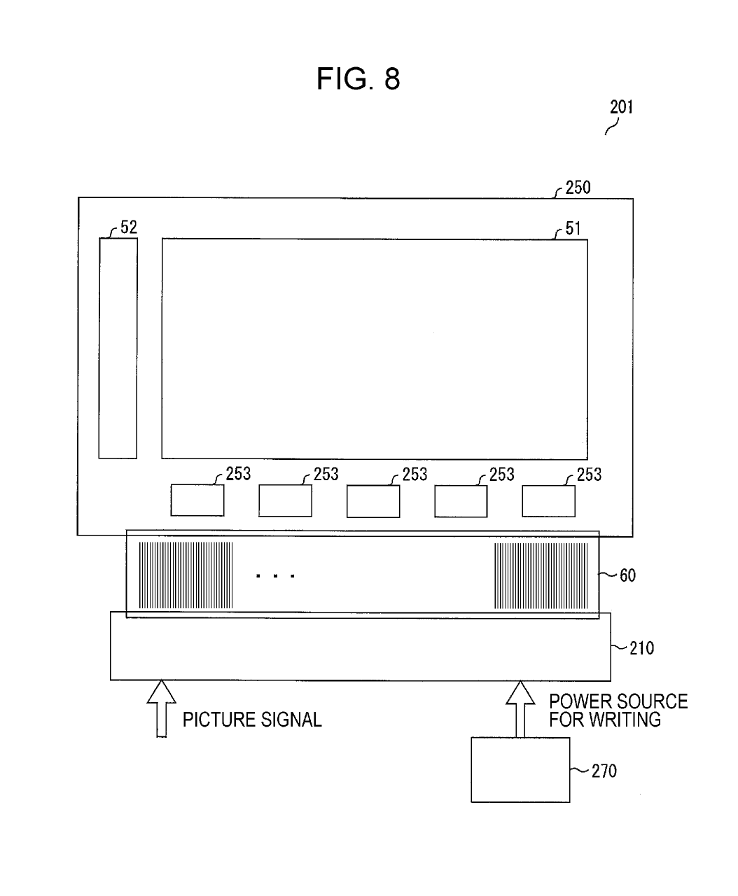

Another embodiment of the present invention will be described with reference to FIGS. 8 to 10 as follows. Note that, for convenience of illustration, members having the same functions as those of the members described in the above-described embodiments are denoted by the same reference characters, and a description thereof will be omitted.

FIG. 8 is a schematic view of a liquid crystal display device according to a third embodiment.

A liquid crystal display device 201 is supplied with a voltage for driving a nonvolatile memory from an external writing device 270 (an external inspection device). After writing to the nonvolatile memory, the writing device 270 inspects whether desired data has been written to the nonvolatile memory, whether a correct display is provided on a display unit 51, or the like.

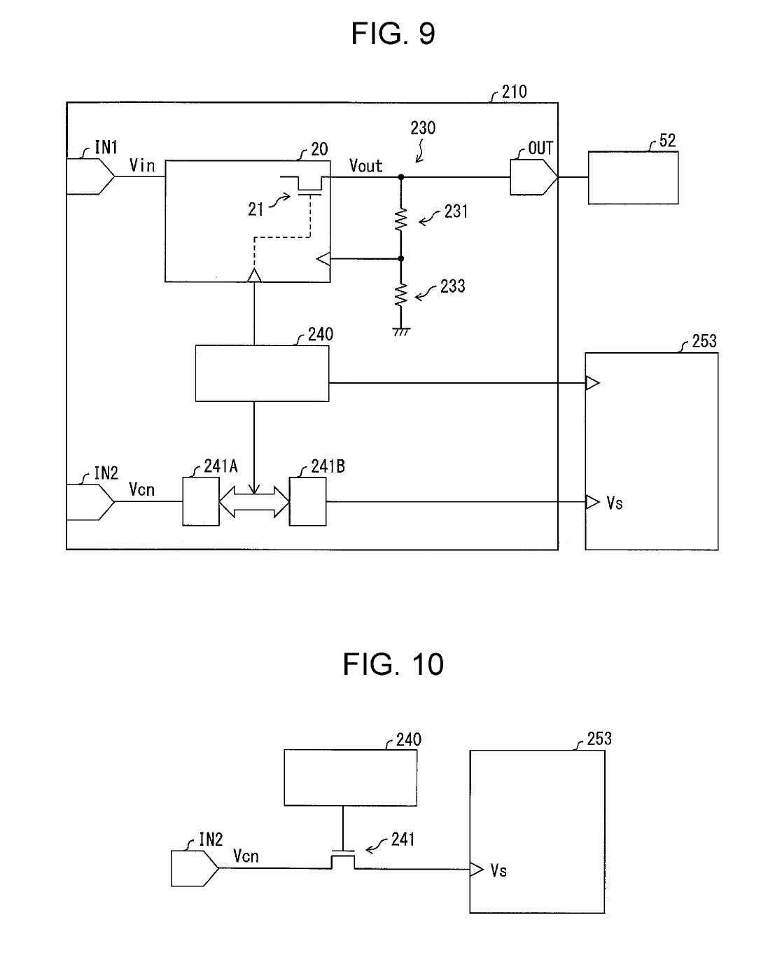

FIG. 9 is a block diagram showing the configuration of the liquid crystal display device according to the third embodiment.

A circuit board 210 according to the present embodiment is provided with an input terminal IN1 and an input terminal IN2.

A predetermined input voltage Vin is supplied from an external power source to the input terminal IN1, and a predetermined input voltage Vcn is supplied from the external writing device 270 to the input terminal IN2. The input voltage Vin is, for example, 3.3 V. The input voltage Vcn is, for example, equal to a voltage Vs for driving a nonvolatile memory and is, for example, ±9 V.

The input terminal IN2 is connected to a connector 241A (a connection land PIN), and the input voltage Vcn is supplied to a source driver 253 via the connector 241A and a connector 241B. Connection between the connector 241A and the connector 241B is controlled by a timing controller 240.

FIG. 10 is a circuit diagram showing a specific configuration of the connectors. As shown in FIG. 10, an FET 241 may be used as the connector 241A and the connector 241B. A source terminal of the FET 241 is connected to the input terminal VIN2, and a drain terminal of the FET 241 is connected to the source driver 253. A gate terminal of the FET 241 is connected to the timing controller 240, and turn-on and turn-off of the FET 241 is controlled by the timing controller 240.

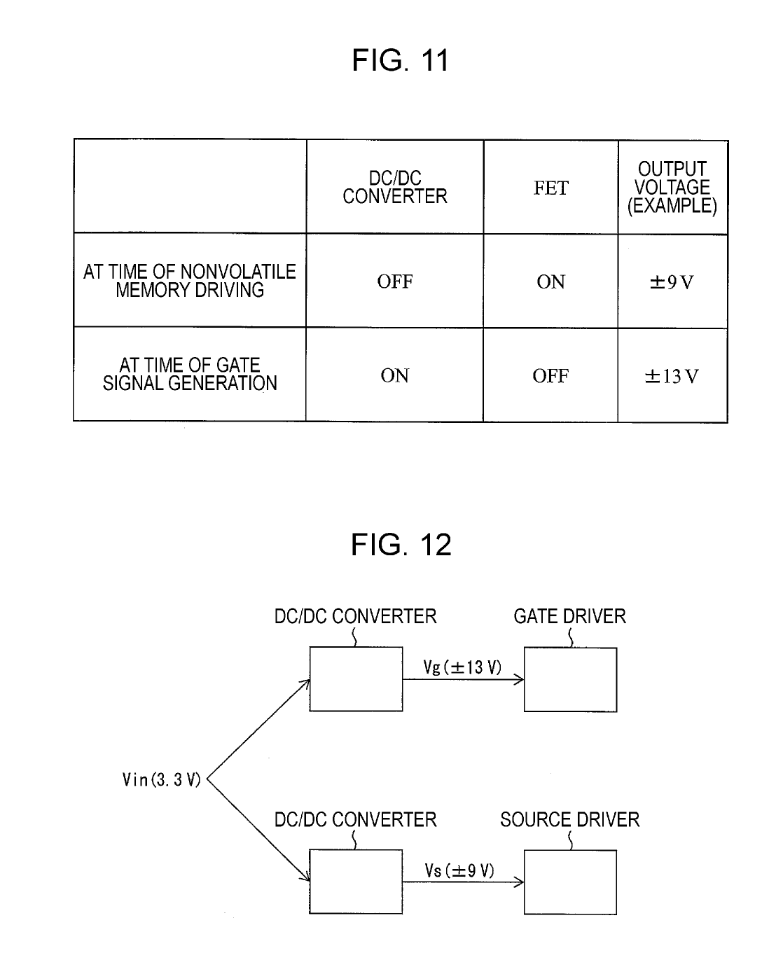

FIG. 11 is a table showing the relationship between the operation of a DC/DC converter and the FET, and an output voltage from the circuit board.

The liquid crystal display device 201 according to the present embodiment deactivates (turns off) a DC/DC converter 20, turns on the FET 241 (brings the FET 241 into a connected state), and supplies the voltage Vs to a nonvolatile memory inside the source driver 253, under control of the timing controller 240 at the time of driving a nonvolatile memory. In contrast, at the time of gate signal generation (at the time of liquid crystal panel gate driving), the liquid crystal display device 201 generates a voltage Vg by turning off the FET 241 (bringing the FET 241 into an unconnected state) and activating (turning on) the DC/DC converter 20 and supplies the voltage Vg to a gate driver 52, under control of the timing controller 240.

That is, the liquid crystal display device 201 according to the present embodiment switches between activation and deactivation of the DC/DC converter 20 and switches the FET 241 on or off, under control of the timing controller 240.

With the above-described configuration, the liquid crystal display device according to the present embodiment can output two types of voltages (Vg and Vs).

In the liquid crystal display device according to the present embodiment, the nonvolatile memory in the source driver 253 is driven using the input voltage Vcn supplied from the writing device 270 without involving the DC/DC converter. For this reason, a predetermined voltage value (±9 V) can be accurately supplied to the nonvolatile memory of the source driver 253. Additionally, a plurality of DC/DC converters need not be simultaneously driven. This facilitates DC/DC converter control and allows a reduction in the risk of causing a malfunction or a breakage.

Note that although an example has been described above in which the DC/DC converter 20 converts the input voltage Vin into the voltage Vg used to generate a gate signal and supplies the input voltage Vcn as the voltage Vs used to drive the nonvolatile memory to the source driver 253, the present invention is not limited to this.

That is, the DC/DC converter 20 may convert the input voltage Vin into the voltage Vs used to drive the nonvolatile memory and supply the input voltage Vcn as the voltage Vg used to generate a gate signal to the gate driver 52.

Note that, in the above description, an N-type FET or a P-type FET may be used as each of the FET 34 and the FET 241 depending on the arrangement location.

### SUMMARY

A display device (the liquid crystal display device 1) according to a first aspect of the present invention is a display device including a scanning line driving circuit (the gate driver 52) which generates a gate signal for sequentially bringing pixels into a selected state and a signal line driving circuit (the source driver 53) which generates a data signal to be supplied to the pixel on the basis of a picture to be displayed, the signal line driving circuit including a nonvolatile memory, in which the display device includes a voltage conversion unit (the DC/DC converter 20) which converts an input voltage (Vin) supplied from the outside into an output voltage (Vout) with a different voltage value and outputs the output voltage, and the voltage conversion unit switches between a first state of converting the input voltage into a first output voltage (the voltage Vs) used to drive the nonvolatile memory and a second state of converting the input voltage into a second output voltage (the voltage Vg) used to generate the gate signal.

With the above-described configuration, it is possible to generate the first output voltage and the second output voltage without use of a plurality of DC/DC converters even if the first output voltage used to drive the nonvolatile memory and the second output voltage used to generate the gate signal are different.

Thus, a size reduction, a power consumption reduction, and a cost reduction can be achieved as compared to a conventional liquid crystal display device.

According to a second aspect of the present invention, the display device of the first aspect may further include a voltage dividing circuit (30, 30A), the voltage dividing circuit may include, as a resistor, an input-side resistor unit and a ground-side resistor unit, the output voltage may be input to the voltage dividing circuit, an output from the voltage dividing circuit may be input as a reference voltage (Vref) to the voltage conversion unit, and the voltage conversion unit may switch between the first state and the second state on the basis of the reference voltage when a resistance value of the input-side resistor unit or the ground-side resistor unit is changed.

With the above-described configuration, it is possible to refer to the output voltage from the voltage dividing circuit and control the output voltage from the voltage conversion unit with a simple configuration.

According to a third aspect of the present invention, in the display device of the second aspect, the ground-side resistor unit may have a first resistor (32) and a second resistor (33) which are connected in parallel, the first resistor may be grounded via a switching element (the FET 34), and a resistance value of the ground-side resistor unit may be changed by controlling opening and closing of the switching element.

With the above-described configuration, it is possible to switch the output voltage from the voltage dividing circuit by changing a resistance value of the voltage dividing circuit using the switching element. It is thus possible to refer to the output voltage from the voltage dividing circuit and switch the output voltage from the voltage conversion unit.

A display device according to a fourth aspect of the present invention is a display device including a scanning line driving circuit (52) which generates a gate signal for sequentially bringing pixels into a selected state and a signal line driving circuit (153) which generates a data signal to be supplied to the pixel on the basis of a picture to be displayed, the signal line driving circuit including a nonvolatile memory, in which the display device includes a first voltage conversion unit (the DC/DC converter 154) which converts an input voltage (Vin) supplied from the outside into a first output voltage (Vs) used to drive the nonvolatile memory and outputs the first output voltage and a second voltage conversion unit (the DC/DC converter 20) which converts the input voltage into a second output voltage (Vg) used to generate the gate signal and outputs the second output voltage, the second voltage conversion unit stops operation during a period when the first voltage conversion unit outputs the first output voltage, and the first voltage conversion unit stops operation during a period when the second voltage conversion unit outputs the second output voltage.

With the above-described configuration, it is possible to convert the input voltage into two types of voltages using the first voltage conversion unit and the second voltage conversion unit. The first voltage conversion unit and the second voltage conversion unit are not simultaneously driven. This facilitates voltage conversion unit control and allows a reduction in the risk of causing a malfunction or a breakage.

A display device (the liquid crystal display device 201) according to a fifth aspect of the present invention is a display device including a scanning line driving circuit (the gate driver 52) which generates a gate signal for sequentially bringing pixels into a selected state and a signal line driving circuit (the source driver 253) which generates a data signal to be supplied to the pixel on the basis of a picture to be displayed, the signal line driving circuit including a nonvolatile memory,

in which the display device includes a voltage conversion unit (the DC/DC converter 20) which converts an input voltage (Vin) supplied from the outside and outputs, as an output voltage, one of a first output voltage (Vs) used to drive the nonvolatile memory and a second output voltage (Vg) used to generate the gate signal,

an input terminal (IN2) which is supplied with a second input voltage (Vcn) equal to a voltage value of the other of the first output voltage and the second output voltage from the outside, and

a switching element (the FET 241) which controls a condition of connection between the input terminal and the scanning line driving circuit or the nonvolatile memory, and

the switching element is in an unconnected state during a period when the voltage conversion unit outputs the output voltage and is in a connected state during a period when the voltage conversion unit does not output the output voltage.

With the above-described configuration, it is possible to drive the nonvolatile memory and generate the gate signal on the basis of the two input voltages. Since the second input voltage equal to the voltage value of the other of the first output voltage and the second output voltage is supplied from the outside, writing to the nonvolatile memory or generation of the gate signal can be performed without involving the DC/DC converter. It is thus possible to accurately supply a predetermined voltage value (±9 V) to the nonvolatile memory of the source driver. Additionally, a plurality of DC/DC converters need not be simultaneously driven. This facilitates DC/DC converter control and allows a reduction in the risk of causing a malfunction or a breakage.

The present invention is not limited to the above-described embodiments, and various types of changes may be made within the scope of the claims. An embodiment obtained by appropriately combining technical means disclosed in different embodiments can also be included in the technical scope of the present invention. Additionally, a new technical feature can be formed by combining technical means disclosed in the embodiments.

### INDUSTRIAL APPLICABILITY

The present invention can be suitably used for an active matrix addressed display device.

### REFERENCE SIGNS LIST

1, 201 liquid crystal display device (display device)
20 DC/DC converter (voltage conversion unit or first voltage conversion unit)
30, 30A voltage dividing circuit
31 resistor (input-side resistor unit)
32 resistor (ground-side resistor unit or first resistor)
33 resistor (ground-side resistor unit or second resistor)
52 gate driver (scanning line driving circuit)
53, 153, 253 source driver (signal line driving circuit)
154 DC/DC converter (second voltage conversion unit)
34 FET (switching element)
Vin input voltage
Vcn input voltage
Vout output voltage
Vref reference voltage
IN2 input terminal
Vs voltage (first output voltage)
Vg voltage (second output voltage)

1.-5. (canceled)

6. A display device comprising:
a scanning line driving circuit which generates a gate signal for sequentially bringing pixels into a selected state; and
a signal line driving circuit which generates a data signal to be supplied to the pixel on the basis of a picture to be displayed, the signal line driving circuit including a nonvolatile memory, wherein
the display device includes a voltage convertor which converts an input voltage supplied from the outside into an output voltage with a different voltage value and outputs the output voltage, and
the voltage convertor switches between a first state of converting the input voltage into a first output voltage used to drive the nonvolatile memory and a second state of converting the input voltage into a second output voltage used to generate the gate signal.

7. The display device according to claim 6, further comprising:
a voltage dividing circuit, wherein
the voltage dividing circuit includes, as a resistor, an input-side resistor and a ground-side resistor,
the output voltage is input to the voltage dividing circuit, and an output from the voltage dividing circuit is input as a reference voltage to the voltage convertor, and
the voltage convertor switches between the first state and the second state on the basis of the reference voltage when a resistance value of the input-side resistor or the ground-side resistor is changed.

8. The display device according to claim 7, wherein
the ground-side resistor has a first resistor and a second resistor which are connected in parallel,
the first resistor is grounded via a switch, and
a resistance value of the ground-side resistor is changed by controlling opening and closing of the switch.

9. The display device according to claim 7, wherein
the input-side resistor has a third resistor and a fourth resistor which are connected in parallel,
the third resistor is connected to the ground-side resistor via a switch, and
a resistance value of the input-side resistor is changed by controlling opening and closing of the switch.

10. The display device according to claim 7, comprising:
a timing controller, wherein
a control signal output by the timing controller changes the resistance value of the input-side resistor or the ground-side resistor.

11. A display device comprising:
a scanning line driving circuit which generates a gate signal for sequentially bringing pixels into a selected state; and
a signal line driving circuit which generates a data signal to be supplied to the pixel on the basis of a picture to be displayed, the signal line driving circuit including a nonvolatile memory, wherein
the display device includes a first voltage convertor which converts an input voltage supplied from the outside into a first output voltage used to drive the nonvolatile memory and outputs the first output voltage and a second voltage convertor which converts the input voltage into a second output voltage used to generate the gate signal and outputs the second output voltage, and
the second voltage convertor stops operation during a period when the first voltage convertor outputs the first output voltage, and the first voltage convertor stops operation during a period when the second voltage convertor outputs the second output voltage.

12. The display device according to claim 11, wherein
the first voltage convertor is provided inside the signal line driving circuit.

13. The display device according to claim 11, wherein
the first voltage convertor is provided outside the signal line driving circuit.

14. The display device according to claim 11, comprising:
a timing controller, wherein
a control signal output by the timing controller causes the second voltage convertor to stop operation during the period when the first voltage convertor outputs the first output voltage and causes the first voltage convertor to stop operation during the period when the second voltage convertor outputs the second output voltage.

15. A display device comprising:
a scanning line driving circuit which generates a gate signal for sequentially bringing pixels into a selected state; and
a signal line driving circuit which generates a data signal to be supplied to the pixel on the basis of a picture to be displayed, the signal line driving circuit including a nonvolatile memory, wherein
the display device includes
a voltage convertor which converts an input voltage supplied from the outside and outputs, as an output voltage, one of a first output voltage used to drive the nonvolatile memory and a second output voltage used to generate the gate signal,
an input terminal which is supplied with a second input voltage equal to a voltage value of the other of the first output voltage and the second output voltage from the outside, and
a switch which controls a condition of connection between the input terminal and the scanning line driving circuit or the nonvolatile memory, and
the switch is in an unconnected state during a period when the voltage convertor outputs the output voltage and is in a connected state during a period when the voltage convertor does not output the output voltage.

16. The display device according to claim 15, wherein
the voltage convertor outputs the second output voltage, and
the input terminal is supplied with the second input voltage equal to a voltage value of the first output voltage.

17. The display device according to claim 15, wherein
the voltage convertor outputs the first output voltage, and
the input terminal is supplied with the second input voltage equal to a voltage value of the second output voltage.

18. The display device according to claim 15, comprising:
a timing controller, wherein
the switch is controlled by a control signal output by the timing controller.
